(19) United States
(12) Patent Application Publication
(10) Pub. No.: US 2003/0211793 A1
(43) Pub. Date: Nov. 13, 2003

(54) Injectable bio-compatible material and methods of use

(76) Inventors: Eugene Bell, Boston, MA (US); Timothy W. Fofonoff, Dedham, MA (US)

Correspondence Address: Anita L Meiklejohn, Fish & Richardson, 225 Franklin Street, Boston, MA, 02110-2804, US

(21) Appl. No.: 10/221,002

(22) PCT Filed: Mar. 5, 2001
(86) PCT No.: PCT/US01/07348

(51) Int. Cl. B32B 27/04; B32B 27/12; B32B 3/00

(52) U.S. Cl. 442/123; 442/59

(57) ABSTRACT

A bio-compatible material which has a microstructure that is amenable to infiltration by living cells and which can support substantial and extended occupation by such living cells. In an embodiment, the bio-compatible material comprises a biopolymer, such as collagen. In another embodiment of the invention, the bio-compatible material is injectable (i.e., it can be applied percutaneously or internally by way of injection through a syringe needle). In a particularly advantageous embodiment, a fibrous bio-compatible material comprises a linearly assembled biopolymer fiber, which is assembled from biopolymer fibrils whose axes are substantially parallel with the axis of said biopolymer fiber.

This application claims the benefit of priority under 35 U.S.C. 119(e) to copending U.S. Provisional Application No. 60/187,191, filed Mar. 6, 2000, the entire contents of which are incorporated herein by reference.

### BACKGROUND OF THE INVENTION

The need to replace tissue that has been lost to disease, injury, or as a result of surgical intervention has been a long standing one. Although wound repair can occur in the absence of tissue replacement, such wound repair is often accompanied by severe scarring and loss of function. If a patient further suffers from a circulatory disorder or from diabetes, a dermal wound may fail to heal for months or years. This extended failure of wound healing often leads to infection and chronic discomfort. More seriously, under many circumstances severe tissue loss can be life threatening, and replacement or surgical restoration becomes an absolute necessity.

One approach to accelerating the body's self-healing process is to provide a dermal “scaffolding” made of a biocompatible material populated with appropriate cells. A highly desirable type of scaffolding can be fabricated from a naturally occurring biopolymer fiber such as collagen fiber.

It has been traditionally difficult to prepare, e.g., by spinning, collagen fibers which have dimensional and strength properties like those found in vivo. Fibers produced by methods which preserve the inherent biological information break easily when subjected to minimal mechanical stress. Because the collagen fiber is ultimately destined for introduction in a human body, it is of course desirable that it be free of contamination by extraneous matter and microorganisms.

The use of synthetic materials, such as polyester fiber (DacronT™) or polytetrafluoroethylene (PTFE) (Teflon™), as implants designed to replace diseased or damaged body parts has been extensive. These materials have however, enjoyed limited success. This has been due to the poor biocompatibility of many of these materials which among other problems, frequently initiate persistent inflammatory reactions. Additionally, the failure of the body to integrate these materials, because they do not break down and do not lend themselves to remodeling by tissue cells that may come into contact with them, causes further problems.

Efforts to use animal or human materials have also been unsatisfactory when these materials are crosslinked by formaldehyde or glutaraldehyde, for example. The process of generalized aldehydic crosslinking renders biomaterials sufficiently unrecognizable to tissue cells so that normal remodeling and integration are not promoted. Similarly, other types of chemical processing of animal or human biomaterials, such as extraction with detergents, or hypertonic buffers or hypotonic buffers can alter them to the degree that they are ineffective in promoting angiogenesis and in stimulating repair and remodeling processes needed for the conversion of an implant into a functional substitute for the tissue or organ being replaced.

A third approach has been that of reconstituting tissue and organ equivalents from structural matrix components, such as collagen, for example, that have been extracted and purified and combined with specialized cells. The process depends upon interactions between the cells and matrix proteins that the cells condense and organize. While tissue-like constructs have been fabricated and been shown to somewhat resemble their natural counterparts, they do not readily develop the matrix complexity characteristic of the actual tissues they are meant to imitate.

### SUMMARY OF THE INVENTION

The present invention relates to a bio-compatible material which has a microstructure that is amenable to infiltration by living cells and which can support substantial and extended occupation by such living cells. In a preferred embodiment, the bio-compatible material comprises a biopolymer, such as collagen. In another embodiment of the invention, the bio-compatible material is injectable (i.e., it can be applied percutaneously or internally by way of injection through a syringe needle). In a further embodiment, the bio-compatible material comprises, or is contained in, a physiologically suitable carrier (e.g., saline). In further preferred embodiments of the invention, the microstructure of the bio-compatible material comprises an agent selected from the group consisting of pharmaceuticals, growth factors, hormones, extracellular matrix proteins, genetic matter, cells, cellular material, and combinations thereof. In yet another embodiment, the genetic matter described above comprises a viral vector.

In a particularly advantageous embodiment, a fibrous bio-compatible material comprises a linearly assembled biopolymer fiber, which is assembled from biopolymer fibrils whose axes are substantially parallel with the axis of said biopolymer fiber. In a preferred embodiment thereof, the fibrous bio-compatible material is injectable. In another preferred embodiment, the fibrous bio-compatible material comprises a plurality of linearly assembled biopolymer fibers. In a further embodiment, the linearly assembled biopolymer fibers of the invention are of heterogeneous length. Another embodiment includes a fibrous bio-compatible material comprising linearly assembled biopolymer fibers which have a digitated form (e.g. microfibrillar burr-like protrusions, microfibrillar tangential protrusions). In a further preferred embodiment of the invention described herein, the linearly assembled biopolymer fibers of the biocompatible material are of sufficient (i.e., suitable) length to cause entanglement with biopolymer fibers of other biocompatible materials. In another preferred embodiment, the linearly assembled biopolymer fibers which comprise the fibrous bio-compatible material are about 1 cm to about 8×10⁵ cm in length. In another embodiment, the fibrous bio-compatible material comprises a physiological saline carrier. In another preferred embodiment, the linearly assembled biopolymer fibers comprise an agent selected from the group consisting of pharmaceuticals, growth factors, hormones, extracellular matrix components, genetic matter, cells, and combinations thereof. In a further embodiment, the genetic matter described above comprises a viral vector. In another preferred embodiment, the fibrous bio-compatible material further comprises collagen. In another embodiment, the fibrous bio-compatible material further comprises collagen foam.

In another embodiment of the present invention, a method of ameliorating a tissue deficit or disorder in described. This method comprises contacting the site of the tissue deficit or disorder with a bio-compatible material which has a microstructure which is amenable to infiltration by living cells and which supports substantial and extended occupation by living cells. In a preferred embodiment of the invention described herein, the tissue deficit or disorder is a bone disease, cartilage disease, cosmetic defects, dermal wounds caused by circulatory disorders, or dermal wounds caused by diabetes. In another embodiment, the biocompatible material is directly applied to the area(s) affected by a tissue deficit or disorder. In another preferred embodiment, the bio-compatible material is injected percutaneously to ameliorate a tissue deficit or disorder. In another preferred embodiment, the biocompatible material used in the treatment method described above comprises a plurality of linearly assembled biopolymer fibers which are assembled from biopolymer fibrils whose axes are substantially parallel with the axis of the biopolymer fibers. In another embodiment, the biocompatible material used in the treatment method described above is obtained by freeze-drying a suspension of collagen fibrils. In a preferred embodiment of the treatment method described above, the length of linearly assembled biopolymer fibers, which comprise the bio-compatible material, is from about 1 cm to about 8×10⁵ cm. In another preferred embodiment of the treatment method described above, the biocompatible material comprises, or is contained within, a physiological saline carrier. In another preferred embodiment of the treatment method described above, the substantially aligned biopolymer fibers have a microstructure comprising a digitated form having a plurality of microfibrillar burr-like protrusions (e.g. microfibrillar tangential protrusions). In another preferred embodiment of the treatment method described above, percutaneous injection of the biocompatible material causes the constituent fibers to entangle and to form a porous mass. In a related embodiment, the pores of the porous mass have a diameter of from about 1 μm to about 1000 μm. In other embodiments of the treatment method described above, the biopolymer comprises collagen. In other preferred embodiments of the treatment method described above, the biopolymer comprises fibrillar collagen foam. In yet another preferred embodiment of the treatment method described above, the linearly assembled biopolymer fibers comprise an agent selected from the group consisting of pharmaceuticals, growth factors, hormones, extracellular matrix components, genetic matter, cells and combinations thereof. In another preferred embodiment of the treatment method described above, the genetic matter comprises a viral vector.

Other embodiments of the invention described herein include those relating to an injectable biopolymer fiber made by a process comprising:

a) creating a vertically-directed flow of coagulation fluid having an upstream direction and a downstream direction,

b) injecting, into the downstream direction of the vertically-directed flow of coagulation fluid, a stream of uncoagulated biocompatible biopolymer selected to coagulate in response to contact with the coagulation fluid, the stream being injected so as to be surrounded by coagulation fluid and propelled in the downstream direction by the vertically-directed flow of coagulation fluid, and

c) allowing the coagulation fluid to coagulate the biopolymer stream, thereby forming a biopolymer fiber.

In a further embodiment of the process described above, the uncoagulated biocompatible biopolymer is a liquid collagen solution. In yet a further embodiment of the process described above, the concentration of collagen in the collagen solution may vary from about 5 mg/ml to about 20 mg/ml. In yet a further embodiment of the process described above, the coagulation fluid is a solution comprising triethanolamine. In a related and preferred embodiment, the concentration of triethanolamine in the coagulation fluid may vary from about 20 mM to about 100 mM. In yet a further embodiment of the process described above, the coagulation fluid is a solution comprising HEPES at a concentration at about 100 mM. In another further embodiment of the process described above, the biocompatible biopolymer is maintained at a temperature of approximately 4° C. In a further embodiment of the process described above, the coagulation fluid is maintained at a temperature which may vary from about 4° C. to about 37° C. In yet a further embodiment of the process described above, the process may further include a step of providing a flow of propulsion fluid to propel the biopolymer stream in the downstream direction.

In yet another embodiment, the invention includes a tissue replacement material which comprises a plurality of linearly assembled collagen fibers, which are assembled from collagen fibrils whose axes are substantially parallel with the axis of the collagen fibers. The unique morphology of the linearly assembled biopolymer fibers of the invention results in a highly biocompatible fiber, i.e., one more likely to be accepted in vivo and form a matrix within which cells can populate. The lengths of these linearly assembled biopolymer fibers, in an embodiment, are effective to cause entanglement with other such fibers. When these fibers are injected in vivo, the fibers entangle with one another so as to form a matrix within which cells can populate. The formation of these fibers may advantageously be accomplished by means of an apparatus and method such as disclosed in a copending Application (Attorney Docket No. TSS-030), filed of even date, the entire contents of which are incorporated herein by reference. This process produces a fiber in a manner that reduces the mechanical stress on the fiber by providing a fiber-formation tube that defines a tube axis extending generally vertically from an upper end to a lower end and having an inner wall defining a bore within the fiber-formation tube. At the upper end of the fiber-formation tube is a fluid inlet for establishing a flow of coagulation fluid in a coagulation zone of the bore. A spinneret is then coupled to the bore at a point downstream from the fluid inlet so as to introduce a biopolymer into the coagulation zone. When introduced to the coagulation zone in this manner, the biopolymer is immediately surrounded by coagulation fluid. At the same time, the flow of coagulation fluid keeps the biopolymer from contacting the inner wall of the bore and sweeps the biopolymer downstream as it coagulates.

At a selected distance downstream from the spinneret, the biopolymer stream is fully coagulated to form a biopolymer fiber. At this point, or alternatively, anywhere downstream from this point, a fluid outlet is provided to separate the coagulation fluid from the coagulated biopolymer fiber. In another embodiment, the fiber is collected and retained with the coagulation fluid.

In either of these embodiments, coagulation of the fiber can be followed by crosslinking of the fiber. This is achieved by adding cross-linking agents to the coagulation fluid or to a fluid that replaces the coagulation fluid. Cross-linking agents known in the art include genipin, glutaraldehyde, formaldehyde, sugars, bisacrylamides, acrylamide, carbodiimides, such as 1-ethyl-3-(dimethyaminopropyl) carbodiimide, diones such as 2,5-hexanedione, diimidates, such as dimethylsuberimidate, or bisacrylamides, such as N,N′-methylenebisacrylamide.

The apparatus can further minimize the mechanical stress experienced by the fiber as it coagulates by establishing a laminar flow of coagulation fluid within a laminar zone of the bore. As used herein, “laminar flow” refers to uniform laminar flow in which the velocity profile of the flow is symmetric about the tube axis. The term “non-uniform flow” refers to flow having an asymmetric velocity profile. This includes both laminar flow having an asymmetric velocity profile and non-laminar flow.

In this embodiment, the coagulation fluid inlet is coupled to an upstream end of the fiber-formation tube and disposed to create a laminar flow generally parallel to the tube axis. As a result of the laminar flow, no significant transverse forces disturb the coagulating fiber.

The process and apparatus allow for the fibers to be relatively free of any mechanical stresses during fiber formation, allowing for the production of very long and fine fibers approaching the dimensions and strengths of iii vivo fibers.

Because the fiber-formation tube is narrow, only a limited amount of coagulation fluid is needed. As a result, it is economically feasible to discard coagulation fluid after a single use and to use only fresh coagulation fluid during the fiber-formation process. This enables the resulting fiber to be more readily made aseptic and, therefore, more suitable for use in a patient.

The above method includes the steps of generating a laminar flow of coagulation fluid having an upstream direction and a downstream direction and introducing a biopolymer stream into the laminar flow. The coagulation fluid envelops the biopolymer stream and propels it in the downstream direction while coagulating it. In this way, a biopolymer fiber is formed. The biopolymer fiber may then be separated from the coagulation fluid if desired. In one embodiment, the separation is accomplished by providing a fluid diverter. In another embodiment, the separation is accomplished by surrounding the fiber with a dehydration fluid.

The foregoing and other objects, features, and advantages of the invention will be apparent from the following description and apparent from the accompanying drawings, in which like reference characters refer to the same parts throughout the different views. The drawings illustrate principles of the invention and are not necessarily to scale.

### BRIEF DESCRIPTION OF THE DRAWING

FIG. 1 shows a biopolymer formation apparatus in accordance with the principles of the invention;

FIG. 2 shows a cross section along the line 2-2′ at the upper end of the fiber-formation tube shown in FIG. 1;

FIG. 3 is a cut-away view of the fiber-formation tube shown in FIG. 1, offering a more detailed view of a spinneret mounted at its upper end;

FIG. 4 is a cut-away view of a filter-formation tube showing details of the manner in which the spinneret is mounted in the tube;

FIG. 5 shows a fluid diverter mounted at the lower end of the fiber-formation tube shown in FIG. 1; and

FIG. 6 shows a dehydration tube mounted at the lower end of the fiber-formation tube shown in FIG. 1.

### DETAILED DESCRIPTION OF THE INVENTION

The injectable material disclosed herein comprises, in a preferred embodiment, a linearly assembled biopolymer fiber, which is assembled from biopolymer fibrils whose axes are substantially parallel with the axis of said biopolymer fiber. These linearly assembled fibers appear to be comprised of an outer core of biopolymer, e.g., collagen, fiber surrounding a core of biopolymer which may include fibers and fibrils, which are in linear alignment with the axis of the collagen fiber “superstructure” The unique morphology of these linearly assembled fibers results in a highly biocompatible fiber, i.e., one more likely to be accepted in vivo and form a matrix within which cells can populate. Other injectable bio-compatible materials which have a microstructure that is amenable to infiltration by living cells and which can support substantial and extended occupation by such living cells include matts and foams, and may also be used in the therapeutic methods of the invention. Such matts, e.g., as described in pending U.S. patent application Ser. No. 09/042,549, filed Mar. 17, 1998, the entire disclosure of which is incorporated herein by reference and foams, e.g., may be used to ameliorate tissue deficit or disorders such as bone disease, cartilage disease, dermal wounds caused by circulatory disorders, and dermal wounds caused by diabetes, by injecting the composition percutaneously.

These fibers are advantageously long, in contrast to the prior art. The linearly assembled collagen fibers are on the order of about 1 cm to about 8×10⁵ cm, preferably about 5 to about 50 cm, more preferably about 5 to about 40 cm, even more preferably about 5 to about 30 cm. These lengths are, in an embodiment, effective to cause entanglement with other collagen fibers. When these fibers are injected in vivo, the fibers entangle with one another so as to form a matrix which is amenable to infiltration and substantial and extended occupation by living cells. Surprisingly, such long fibers are very injectable. “Injectable” as used herein, refers to the ability to deliver a fluid preparation comprising the linearly assembled collagen fibers disclosed herein (e.g., a solution, dispersion, or suspension) through a syringe or infusion device. In a preferred embodiment the fluid preparation is delivered through a, e.g., 14 gauge needle, more preferably a 19 gauge needle.

The injectable material of the invention may be used for a variety of beneficial purposes, such as tissue repair, treatment of bone disease, treatment of cosmetic defects, treatment of cartilage disease; treatment of dermal wounds caused by circulatory disorders or from diabetes, and the like. The injectable material may be used in vitro, for example, as model systems for research, or in vivo to make prostheses or implants to replace damaged or diseased tissues or to provide scaffolds which, when occupied by cells, e.g., host cells, are remodeled to become functional tissues. The matrix formed by the injectable material, e.g., collagen, may be seeded with cells, e.g., mammalian cells, e.g., human cells, of the same type as those of the tissue which the matrix formed by the injectable fibrous collagen is used to repair, reconstruct, or replace. Examples of tissues which can be repaired and/or reconstructed using the injectable fibrous collagen described herein include nervous tissue, skin, vascular tissue, cardiac tissue, pericardial tissue, muscle tissue, ocular tissue, periodontal tissue, connective tissue such as bone, cartilage, tendon, and ligament, organ tissue such as kidney tissue, and liver tissue, glandular tissue such as pancreatic tissue, mammary tissue, and adrenal tissue, urological tissue such as bladder tissue and ureter tissue, and digestive tissue such as intestinal tissues.

The linearly assembled fibers contain information to induce the repair or regeneration of damaged, diseased or missing tissue. Additional information for repair or regeneration can be added by mixing other informational macromolecules to the linearly assembled collagen fibers. The linearly assembled fibers are fully resorbable when not reinforced by non-resorbable fibers and over time can be replaced by new normal pure host tissue. The linearly assembled collagen fibers, for example, are more resistant to enzymatic breakdown than other collagen products of high information content, such as gels or foams. The linearly assembled fibers can be produced under physiological conditions, so living cells can be incorporated throughout the structure and on the completed form, thus yielding a living implant. The information content of the linearly assembled fibers can induce authentic healing and repair. For example, a living cell matt can replace the missing host tissue and its function immediately, and still be remodeled by authentic host tissue gradually with no interruption of tissue function. The linearly assembled fibers can be produced in a manner which gives them more strength than other products of high information content. Therefore, they can be used in situations which requires an implant of strength.

The formation of linearly assembled fibers of the invention is advantageously accomplished by means of an apparatus and method such as disclosed in copending Application (Attorney Docket No. TSS-030), filed of even date, the entire contents of which are incorporated herein by reference. This process produces a fiber in a manner that reduces the mechanical stress on the fiber by providing a fiber-formation tube that defines a tube axis extending generally vertically from an upper end to a lower end and having an inner wall defining a bore within the fiber-formation tube. At the upper end of the fiber-formation tube is a fluid inlet for establishing a flow of coagulation fluid in a coagulation zone of the bore. A spinneret is then coupled to the bore at a point downstream from the fluid inlet so as to introduce a biopolymer into the coagulation zone. When introduced to the coagulation zone in this manner, the biopolymer is immediately surrounded by coagulation fluid. At the same time, the flow of coagulation fluid keeps the biopolymer from contacting the inner wall of the bore and sweeps the biopolymer downstream as it coagulates.

The term “biocompatibility” or “biocompatible” as used herein refers to the manner and degree in which a material, such as a composition of the present invention, interacts with body tissues or fluids of an animal or human. A completely biocompatible material shows no adverse effect or interaction with the body, a satisfactory biocompatible material shows only slight adverse effect or interaction with the body, and an incompatible material elicits a severe reaction from the body that it contacts. The term “biocompatible material,” when referring to embodiments of the invention described herein, is meant to include a substance, synthetic or natural, that can be used as a system or part of a system that treats, augments, or replaces any tissue, organ, or function of the body.

The term “fiber,” as used herein, refers to a material that comprises a biopolymer. The term is further mean to include material used in embodiments of the invention which comprise numerous linearly assembled biopolymers. The term “fibrous,” when referring to embodiments of the invention described herein, is meant to include material whose structure comprises one or more fibers.

The term “linearly aligned,” as used herein, is meant describe the quality of a group of biopolymers or fibrils or fibers or combinations thereof, whereby the length axes of these items are in substantial parallel alignment to one another.

The term “linearly assembled,” as used herein, is meant describe the structural quality of a fiber, or other material related to the invention, whereby the fiber or other material is assembled in a linear dimension and, further, may be assembled from linear sub-components (e.g. fibrils, biopolymers) which have axes in substantial alignment with said fiber or material.

The term “digitated,” as used herein, is meant to describe the structures and/or microstructures of various embodiments of the invention. The term generally refers to a plurality of finger-like structures which protrude from a surface, e.g. achinate. The term “digitated” is further used to describe the surface structure of certain fibrous embodiments of the invention which have numerous biopolymer protrusions and/or fibril protrusions (e.g. microfibrillar tangential protrusions). These protrusions may lend a burr-like quality to embodiments of the invention. As used herein, the term “burr-like” describes a quality of a surface or material to be predisposed to entangle with, or to stick or cling to, another digitated surface or material (e.g. a surface with microfibrillar tangential protrusions).

The term “entanglement” as used herein, is meant to describe an event or process, whereby fibrous materials of the invention (e.g. biopolymers, fibers, and fibrils and combinations thereof) become intertwined (e.g. tangled or twisted) along their length with other fibrous materials.

As used herein, the term “foam” refers to a network of communicating microcompartments having biopolymer molecules and/or biopolymer filaments interspersed within the walls of the microcompartments. The term “fibrillar foam” as used herein refers to an embodiment of the invention which comprises a combination foam and biopolymer fibrils. As further used herein, the term “fibrillar collagen foam” refers to an embodiment of the invention which comprises collagen biopolymers. This term may further refer to a material which comprises both collagen foam and collagen fibrils in combination.

As described herein, certain embodiments of the invention are amenable to infiltration and substantial and extended occupation by living cells. The term “infiltration” as used to describe aspects of the invention, is meant to include the biological processes of cellular locomotion, whereby a cell (e.g. a fibroblast, a dermal cell, etc) is able, through coordinated rearrangements of its cytoskeleton, to move along an appropriate natural or synthetic surface. Specifically, cellular infiltration, as is used in one aspect of the invention, involves the migration, or locomotion of cells into the material of the invention from without (i.e. outside the the material of the invention). The term “substantial and extended occupation”, as used herein, is meant to include the event of cells residing upon an appropriate surface (e.g., stratum), either natural or synthetic, and being able to accomplish substantially all necessary cellular functions, e.g., generation of extracellular matrix, cellular division, metabolism, etc.

The term “fibrils” refers to ordered multimers of molecules which create a fibrous overall structure. In the case of collagen fibrils, the collagen molecules are arranged in a quarter stagger, where each side-by-side association of molecules has an orderly shift of about 25% (the head of one collagen molecule is arranged to be juxtaposed to the adjacent molecule about 25% down the chain of that molecule). Fibrils, especially those of collagen often have a characteristic appearance by electron microscopy. Fibrils associate into bundles. Higher multiples of fibril bundles are fibers.

A “biopolymer” is a naturally occurring polymeric substance formed from individual molecules in a biological system or organism. Biopolymers can also be man-made by manipulation of the individual molecules once obtained outside the biological system or organism. The biopolymer is suitable for introduction into a living organism, e.g., a mammal, e.g., a human. The biopolymer is non-toxic and bioabsorbable when introduced into a living organism and any degradation products of the biopolymer should also be non-toxic to the organism, e.g. bio-compatible. Examples of molecules which can form biopolymers and which can be used in the present invention include collagen, laminin, elastin, fibronectin, fibrinogen, thrombospondin, gelatin, polysaccharides, poly-1-amino acids and combinations thereof. A combination or mixture of one or more biopolymers can be used to form the biocompatible fibers of the invention. For example, a combination of laminin and type IV collagen can be used to form the biopolymer fibers described herein. A preferred molecule for biopolymer production is collagen.

Preferred sources of molecules which form biopolymers include mammals such as pigs, e.g., near-term fetal pigs, sheep, fetal sheep, cows, and fetal cows. Other sources of the molecules which can form biopolymers include both land and marine vertebrates and invertebrates. In one embodiment, the collagen can be obtained from skins of near-term, domestic porcine fetuses which are harvested intact, enclosed in their amniotic membranes. Collagen or combinations of collagen types can be used in the matt and matt compositions described herein. Examples of collagen or combinations of collagen types include collagen type I, collagen type II, collagen type III, collagen type IV, collagen type V, collagen type VI, collagen type VII, collagen type VIII, collagen type IX, collagen type X, collagen type XI, collagen type XII, collagen type XIII, and collagen type XIV. A preferred combination of collagen types includes collagen type I, collagen type III, and collagen type IV. Preferred mammalian tissues from which to extract the molecules which can form biopolymer include entire mammalian fetuses, e.g., porcine fetuses, dermis, tendon, muscle and connective tissue. As a source of collagen, fetal tissues are advantageous because the collagen in the fetal tissues is not as heavily crosslinked as in adult tissues. Thus, when the collagen is extracted using acid extraction, a greater percentage of intact collagen molecules is obtained from fetal tissues in comparison to adult tissues. Fetal tissues also include various molecular factors which are present in normal tissue at different stages of animal development.

Collagen solutions can be produced by salt extraction, acid extraction, and/or pepsin extraction from the starting material. In a preferred embodiment, the collagen used is produced by sequentially purifying two forms of collagen from the same collagen-containing starting material. First, intact collagen is acid extracted from the starting material, the extract is collected and collagen is prepared as a collagen solution, e.g., by precipitating the collagen with sodium chloride and solubilizing the collagen in a medium having an acidic pH. Meanwhile, truncated collagen, i.e., collagen from which the telopeptides have been cleaved or partly cleaved leaving only the helical portion or the helical portion with some telopeptides, is extracted from the starting material using enzyme, e.g., an enzyme which is functional at an acidic pH, e.g., pepsin, extraction. Then, the collagen from this pepsin extract is purified separately by similar methods as from the first extract.

In a preferred method for extracting the collagen from tissue, a collagen source includes porcine fetuses. The fetuses are frozen in utero with the uteri maintained in an unbroken condition with the ends tied off by string. Twelve to twenty-four hours before dissection, a uterus is removed from the freezer and placed in a 4° C. cold room. The uterus, which should still be about 90% frozen, is transferred into a large sterile dishpan. As soon as possible, the folded uterus is gently straightened. The exterior surface of the uterus is washed twice for ten minutes in 1% bleach in Milli-Q™ water and is then washed twice with sterile Milli-Q™ water to sterilize the uterus.

Under clean-room conditions using sterile, large tissue grip forceps and large scissors, and wearing sterile gloves, mask, hood and gown, the entire length of the uterus on the surface opposite the major blood vessels is opened. Care is taken not to touch or damage the amniotic membranes of the fetus. Instruments that come in contact with the outer surface of the uterus are washed with 70% ethyl alcohol and sterilized with a Bunsen burner. Each fetus is gently lifted from the uterus and the umbilicus is cut at least two centimeters from the fetus. The still mainly frozen fetus is placed into a stainless steel pan.

With sterile gloves, the amniotic membrane is removed, and the fetus is transferred to a sterile glass dish. With a sterile scalpel, such as a #11 blade, the skin around each foot is sliced to make a circular incision. A single incision is made through the skin from the first cut, along the inner surface of each limb to the midline of the ventral surface of the trunk. A midline incision is made along the ventral surface of the trunk from the tail to the neck, taking care not to penetrate the underlying muscle tissue. A skin deep circular incision is made around the circumference of the head. The body skin is peeled off. The peeled skin is placed into a sterile container (one liter centrifuge bottle with cap) on ice.

The skins are combined with an equal volume of sterile ice, and the ground tissue is washed twice in twenty liters of ice cold 0.33× phosphate buffered saline (PBS):Milli-Q™ water (1:2) with about thirty minutes allowed for tissue to settle between washes. The tissue is evenly divided into one-liter centrifuge bottles as required and each filled with 0.5 M acetic acid and 4 mM EDTA. The centrifuge bottles are placed on a roller bottle apparatus for about seven days at a temperature of about 4° C.

On the eighth day after the beginning of the skin preparation, the centrifuge bottles are spun for thirty minutes at 5,000 rpm. The supernatant is aseptically collected in a sterile carboy (20 or 50 liters). The collected supernatant is filtered through four layers of sterile cheese cloth. Sterile sodium chloride is added to bring the solution to about 0.9 M. It is stirred over a period of about one hour and is then placed in a cold room at about 4° C. overnight. The collagen is resuspended. The entire salt precipitated solution and the precipitate is dispensed into sterile one-liter centrifuge bottles. The bottles are centrifuged at 5,000 rpm for about thirty minutes using a 6× one-liter rotor at about 7,280 gs. The supernatant is removed, and the pellet is kept. To the pellet in each centrifuge bottle, 0.5 M acetic acid having a pH of 2.5 plus 4 mM EDTA is added. The pellets are dispersed in the medium and shaken in a gyrator shaker for about sixteen hours at a temperature of about 4° C. The pellets from the bottles are transferred to a six liter flask, by rinsing each bottle with the 0.5 M acetic acid, EDTA solution and pouring the mix into the flask. In the six liter flask, the pellets are dispersed with a sterile glass rod. The flask is placed on a shaker for twenty-four hours at a temperature of about 4° C. The flask is checked for degree of solubilization and resuspension. More 0.5 M acetic acid and EDTA solution may be added to bring the volume to five liters.

Sterile sodium chloride is added to the flask to bring the solution to about 0.7 M. It is stirred periodically over a period of one hour and then placed in a cold room at a temperature of about 4° C. overnight allowing the salt to precipitate.

The contents are shaken and dispensed into one-liter sterile centrifuge bottles and spun at about 5,000 rpm for 30 minutes at 7,280 gs. A second resuspension is conducted with the step similar to the steps described above for the first resuspension. Instead, of resuspending in six liters, a total volume of two liters is employed in the resuspension process. The flask is shaken in the cold room overnight and its volume adjusted as necessary.

The solution is dialyzed three times for about 20-24 hours against one hundred liters of ice cold 0.05 0.5 M acetic acid in the cold room (4° C.) using 6,000-8,000 MW cutoff, SPECTRAPORE dialysis bags. The dialysis bag is slit with a sterile scalpel blade and the contents transferred into sterile 250 ml centrifuge bottles. The bottles are centrifuged at a temperature of about 4° C. at 10,000 rpm (13,000 g) for one hour. The supernatant is collected and stored in a sterile, sealed bottle.

A 0.5 ml aliquot of the supernatant is removed, combined with equal volume of concentrated hydrogen chloride and the collagen concentration measured using an hydroxyproline assay. The collagen is concentrated to a theoretical concentration of 5 mg/ml using a hollow fiber filter. The concentration can be confirmed with a hydroxyproline assay.

Macromolecules necessary for cell growth, morphogenesis, differentiation, and tissue building can also be added to the biopolymer molecules or to the biopolymer fibrils to further promote cell ingrowth and tissue development and organization within the matt. The phrase “macromolecules necessary for cell growth, morphogenesis, differentiation, and tissue building” refers to those molecules, e.g., macromolecules such as proteins, which participate in the development of tissue. Such molecules contain biological, physiological, and structural information for development or regeneration of the tissue structure and function. Examples of these macromolecules include, but are not limited to, growth factors, extracellular matrix proteins, proteoglycans, glycosaminoglycans and polysaccharides. Alternatively, the biopolymer matts, matt composites, and matt compositions of the invention can include extracellular matrix macromolecules in particulate form or extracellular matrix molecules deposited by cells or viable cells.

The term “growth factors” is art recognized and is intended to include, but is not limited to, one or more of platelet derived growth factors (PDGF), e.g., PDGF AA, PDGF BB; insulin-like growth factors (IGF), e.g., IGF-I, IGF-II; fibroblast growth factors (FGF), e.g., acidic FGF, basic FGF, β-endothelial cell growth factor, FGF 4, FGF 5, FGF 6, FGF 7, FGF 8, and FGF 9; transforming growth factors (TGF), e.g., TGF-β1, TGF-β1.2, TGF-β2, TGF-β3, TGF-β5; bone morphogenic proteins (BMP), e.g., BMP 1, BMP 2, BMP 3, BMP 4; vascular endothelial growth factors (VEGF), e.g., VEGF, placenta growth factor; epidermal growth factors (EGF), e.g., EGF, amphiregulin, betacellulin, heparin binding EGF; interleukins, e.g., IL-1, IL-2, IL-3, IL-4, IL-5, IL-6, IL-7, IL-8, IL-9, IL-10, IL-11, IL-12, IL-13, IL-14; colony stimulating factors (CSF), e.g., CSF-G, CSF-GM, CSF-M; nerve growth factor (NGF); stem cell factor; hepatocyte growth factor, and ciliary neurotrophic factor. The term encompasses presently unknown growth factors that may be discovered in the future, since their characterization as a growth factor will be readily determinable by persons skilled in the art.

The term “extracellular matrix proteins” is art recognized and is intended to include one or more of fibronectin, laminin, vitronectin, tenascin, entactin, thrombospondin, elastin, gelatin, collagens, fibrillin, merosin, anchorin, chondronectin, link protein, bone sialoprotein, osteocalcin, osteopontin, epinectin, hyaluronectin, undulin, epiligrin, and kalinin. The term encompasses presently unknown extracellular matrix proteins that may be discovered in the future, since their characterization as an extracellular matrix protein will be readily determinable by persons skilled in the art.

The term “proteoglycan” is art recognized and is intended to include one or more of decorin and dermatan sulfate proteoglycans, keratin or keratan sulfate proteoglycans, aggrecan or chondroitin sulfate proteoglycans, heparan sulfate proteoglycans, biglycan, syndecan, perlecan, or serglycin. The term encompasses presently unknown proteoglycans that may be discovered in the future, since their characterization as a proteoglycan will be readily determinable by persons skilled in the art.

The term “glycosaminoglycan” is art recognized and is intended to include one or more of heparan sulfate, chondroitin sulfate, dermatan sulfate, keratan sulfate, hyaluronic acid. The term encompasses presently unknown glycosaminoglycans that may be discovered in the future, since their characterization as a glycosaminoglycan will be readily determinable by persons skilled in the art.

The term “polysaccharide” is art recognized and is intended to include one or more of heparin, dextran sulfate, chitin, alginic acid, pectin, and xylan. The term encompasses presently unknown polysaccharides that may be discovered in the future, since their characterization as a polysaccharide will be readily determinable by persons skilled in the art.

Suitable living cells include, but are not limited to, epithelial cells, e.g., keratinocytes, adipocytes, hepatocytes, neurons, glial cells, astrocytes, podocytes, mammary epithelial cells, islet cells; endothelial cells, e.g., aortic, capillary and vein endothelial cells; and mesenchymal cells, e.g., dermal fibroblasts, mesothelial cells, stem cells, osteoblasts, smooth muscle cells, striated muscle cells, ligament fibroblasts, tendon fibroblasts, chondrocytes, and fibroblasts.

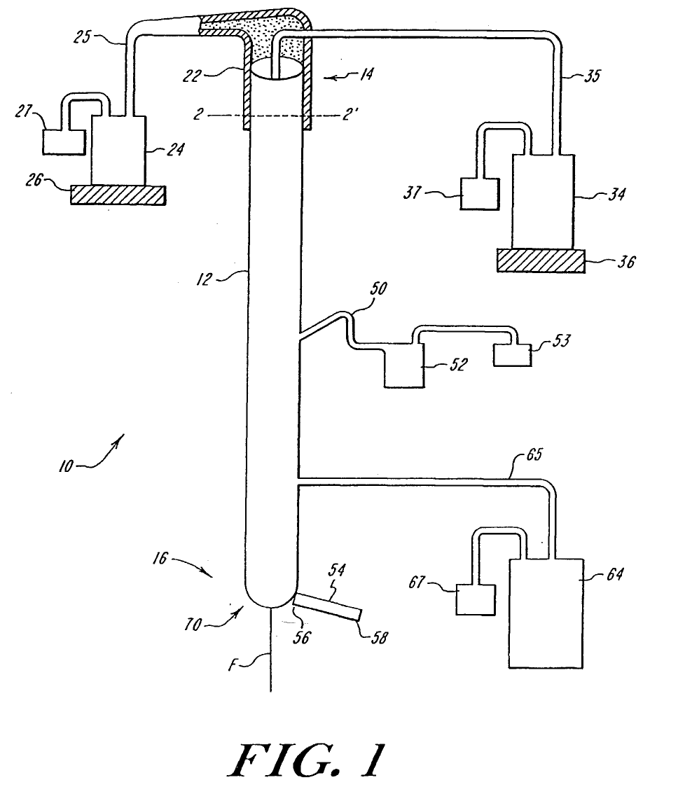

Referring to FIG. 1, an apparatus 10 for the formation of a biocompatible biopolymer fiber F in accordance with the principles of the invention includes a fiber-formation tube 12 extending along a tube axis X in a generally vertical direction between an upper end 14 and a lower end 16. The length of the fiber-formation tube 12 is sufficient to enable a liquid biopolymer extruded into a flow of coagulation fluid at the upper end 14 to coagulate into a biopolymer fiber before it emerges from the lower end 16. Typically, the length of the fiber-formation tube 12 is selected to be between about six inches and about sixty inches, although other lengths can also be used.

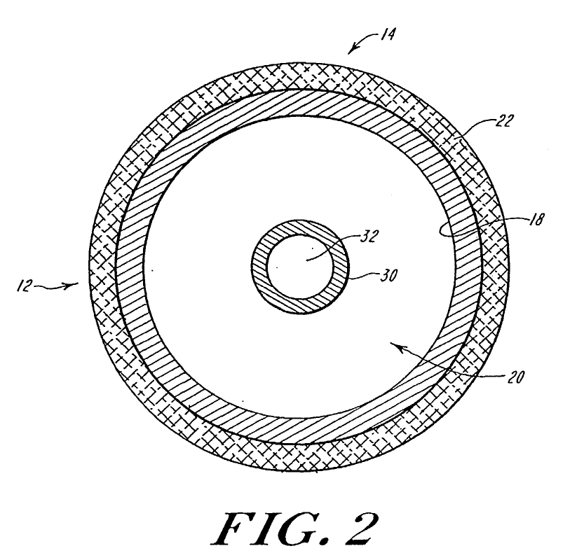

As shown in cross-section in FIG. 2, the fiber-formation tube 12 is a hollow cylindrical tube having an inner wall 18 defining a bore or lumen 20 coaxial with the fiber-formation tube 12. Since fluid flow is generally laminar immediately adjacent to a surface such as the inner wall 18, it is preferable to select the diameter of the bore 20 to be small enough to enhance the likelihood of uniform laminar flow throughout its cross-section. It is thus preferable to select the diameter of the bore 20 to be no wider than necessary to accommodate the diameter of the biopolymer fiber F to be formed, together with an annular layer of coagulation fluid between the biopolymer fiber F and the inner wall 18. This diameter will depend on the viscosity and rate of flow of the coagulation fluid. However, a typical range of diameters for the bore 20 is a range between about 0.01 and 0.10 inches. Preferably, the diameter of the bore 20 is about 0.032 inches, although other diameters can also be used.

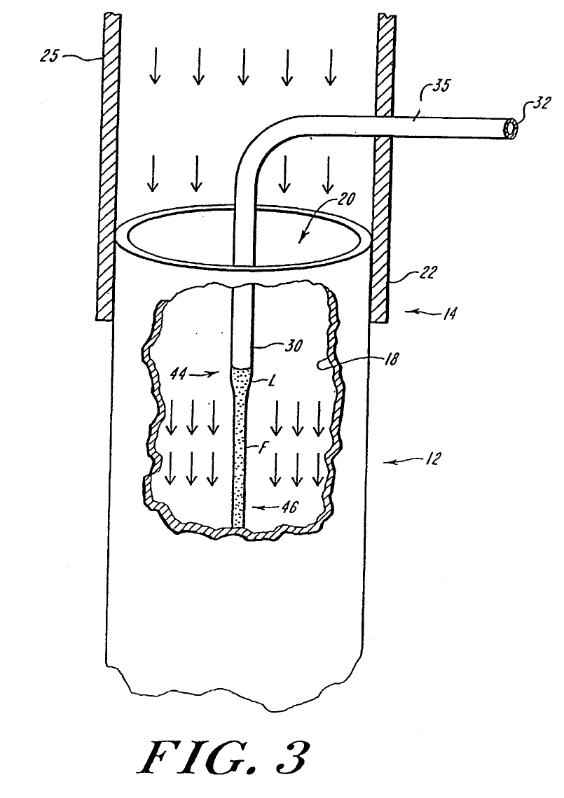

With references to FIGS. 1 to 3, the upper end 14 of the fiber-formation tube 12 supports a coagulation-fluid inlet 22, best seen in the cut-away view of the upper end 14 in FIG. 3 and in cross-section in FIG. 2. This coagulation-fluid inlet 22 is coupled to a coagulation-fluid reservoir 24 by a coagulation-fluid feeder tube 25. In a preferred embodiment, the coagulation fluid feeder tube 25 is an elastomeric feeder tube and the coagulation fluid inlet 22 is formed by stretching the end of the elastomeric feeder tube over the upper end 14 of the fiber-formation column 12. The coagulation-fluid reservoir 24 contains a coagulation fluid that changes the form of the biopolymer from liquid to semisolid by changing the pH, the solution structure, and/or the temperature. Examples of liquids that can change solution structure include organic solvents (including ethanol, acetone, and methanol) or salts (such as NaCl or ammonium sulfate) that precipitate proteins. Examples of liquids that can change pH include buffering agents such as phosphate, HEPES, triethanolamine, tricine, trizma, and caps. Ranges of buffering agent concentrations are between 3 mM and 1000 mM. Preferably, the ranges are between 10 mM and 200 mM, and more preferably, between 5 mM and 100 mM. For triethanolamine coagulation fluids, the concentration of triethanolamine is between about 10 and 200 mM. For HEPES coagulation fluids, the HEPES concentration is typically in the vicinity of 100 mM.

Preferably, the coagulation-fluid reservoir 24 includes a temperature controller 26 for maintaining the temperature of the coagulation fluid in the range between about 4° C. and 37° C. A head source 27 is disposed in fluid communication with the coagulation-fluid reservoir 24 through the fiber-formation tube 12. The head source 27 can be a compressor in pneumatic communication with a headspace in the coagulation-fluid reservoir 24 and adapted to deliver coagulation fluid by metering an inert gas under pressure into the headspace of the reservoir. Alternatively, the head source 27 can be a metering pump through which a metered quantity of coagulation fluid is pumped through the coagulation fluid feeder tube 25.

The upper end 14 of the fiber-formation tube 12 also supports a spinneret 30, best seen in FIG. 3, and in cross-section in FIG. 2. The spinneret 30 is a generally cylindrical tube defining a lumen 32 through which liquid biopolymer passes before entering the fiber-formation tube 12. The tube forming the spinneret 30 has a length typically between about 1 inch and about 3.5 inches. The lumen 32 of the spinneret 30 has a diameter between about 0.006 inches and about 0.016 inches, although other lengths and diameters can also be used.

The spinneret 30 is coupled to a biopolymer reservoir 34 by a biopolymer-feeder tube 35. The biopolymer reservoir 34 contains a liquid biocompatible biopolymer, such as a liquid collagen solution, that coagulates when exposed to the coagulation fluid. A preferred liquid collagen solution used in the practice of the invention has a collagen concentration between about 5 and 40 mg/ml and more preferably between 10 and 20 mg/ml. Preferably, the biopolymer reservoir 34 includes a temperature controller 36 for maintaining the temperature of the biopolymer at approximately 4° C. A head-source 37 in fluid communication with the biopolymer reservoir 34 drives the liquid biopolymer in the biopolymer reservoir 34 through the biopolymer-feeder tube 35 and into the fiber-formation tube 12. The head source 37 can be a compressor in pneumatic communication with a headspace in the biopolymer reservoir 34 and adapted to deliver liquid biopolymer by metering an inert gas under pressure into the headspace of the reservoir. Alternatively, the head source 37 can be a metering pump through which a metered quantity of liquid biopolymer is pumped through the biopolymer-feeder tube 35.

In one embodiment, the spinneret 30 is mounted at an angle to the axis X of the fiber-formation tube 12 so that liquid biopolymer extruded from the spinneret 30 emerges as far as possible from the inner wall 18 of the fiber-formation tube 12. Alternatively, the spinneret 30 can be mounted so that liquid biopolymer extruded from the spinneret 30 is introduced coaxial to the axis X of the fiber-formation tube 12. Both of these dispositions of the spinneret 30 reduce the possibility that the biopolymer stream will be swept against the inner wall 18 by the flow of coagulation fluid.

The pressure provided by the head source 37 establishes a flow of liquid biopolymer into the bore 20 of the fiber-formation tube 12 by forcing liquid biopolymer from the biopolymer reservoir 34, through the biopolymer-feeder tube 35, through the lumen 32 of the spinneret 30, and into the bore 20. The volume rate of flow of liquid biopolymer through the spinneret 30, and hence into the fiber-formation tube 12, can be controlled by regulating the output of the head source 37.

Likewise, the pressure provided by the head source 27 establishes a flow of coagulation fluid into the bore 20 of the fiber-formation tube 12 by forcing coagulation fluid from the coagulation-fluid reservoir 24, through the coagulation-fluid feeder tube 25, through the coagulation-fluid inlet 22, and into the bore 20. The volume rate of flow of coagulation fluid into the fiber-formation tube 12 can be controlled by regulating the output of the head source.

As the coagulation fluid flows downstream in the fiber-formation tube 12, the non-uniform flow dissipates and the flow becomes progressively uniform, until it is generally, substantially, and completely uniform along at least a portion of the tube 12. The fluid flow present in this second zone, referred to as the laminar zone 44, is schematically illustrated in FIG. 3. As shown in FIG. 3, the spinneret 30 is advantageously mounted so that liquid biopolymer L extruded from the spinneret 30 emerges into a laminar flow of coagulation-fluid in the laminar zone 44. This laminar flow of coagulation-fluid enables the biopolymer stream to remain intact. As a result, upon exposure to the laminar flow of coagulation fluid, the liquid biopolymer L coagulates into a continuous fiber F as it flows through a coagulation zone. All liquids to be used in the system are degassed sufficiently by methods known by one of ordinary skill in the art to prevent possible changes in flow rate caused by the formation of bubbles within the tubing bores.

Because the laminar flow of coagulation fluid is in contact with the liquid biopolymer, the velocity of the coagulation fluid and the velocity of the liquid biopolymer are coupled. This allows the liquid biopolymer L to be swept downstream by the flow of the coagulation fluid. As a result, it is possible to adjust the diameter of the resulting fiber F by adjusting the relative flow velocities of the coagulation fluid flowing through the fiber-formation tube 12 and the liquid biopolymer flowing through the spinneret 30. This can be achieved by adjusting the flow-rate of the coagulation fluid, the flow rate of the liquid biopolymer, or both. When the coagulation fluid flows slowly relative to the liquid biopolymer, the stream of liquid biopolymer coagulates before the flow of coagulation fluid can reduce the diameter of the extruded stream significantly. The biopolymer fiber thus formed is relatively coarse. Conversely, if the coagulation fluid flows quickly relative to the liquid biopolymer, the biopolymer stream is drawn out into a thin fiber by the flow before it can fully coagulate. The fiber thus formed is relatively fine. A fine fiber is preferable for forming the scaffolding used in tissue replacement because such a fiber has dimensions that are closer to those of naturally occurring collagen fibers. A fine fiber also has greater tensile strength and can be dried at higher speeds without a significant risk of breakage.

Since the diameter of the bore 20 of the fiber-formation tube 12 is only slightly larger than the diameter of the fiber, there is a possibility that the fiber will contact the inner wall 18 of the fiber-formation tube 12 before reaching the fluid outlet 70. This can result in undesirable mechanical stress on the fiber. Additionally, the fiber could adhere to the inner wall 18. If this were to occur, a loop of fiber would form in the bore as additional fiber extruded from the spinneret 30 passes downstream of the portion of fiber adhered to the inner wall 18. This could quickly result in blockage of the bore 20.

The laminar flow of coagulation fluid in the fiber-formation tube 12 reduces the likelihood of the above-mentioned risks by reducing the likelihood that the fiber will contact the inner wall 18 of the fiber-formation tube 12. This occurs because the fiber will naturally follow the streamlines of the flow in which it is placed. Since the streamlines in laminar flow are parallel to the inner wall 18, and since the stream of liquid biopolymer is introduced along the axis X of the fiber-formation tube 12, the laminar flow in the bore 20 will tend to maintain the fiber collinear with the axis X of the fiber-formation tube 12 and away from the inner wall 18. This results in a fiber having a circular cross-section and minimal surface imperfections.

The embodiment of the present invention disclosed herein thus provides a spinneret 30 for extruding a stream of liquid biopolymer L into a downward laminar flow of coagulation fluid in a generally vertical fiber-formation tube 12. The extruded liquid biopolymer L is swept downward by the laminar flow of coagulation fluid and coagulated into a biopolymer fiber F. The diameter of this biopolymer fiber F can be controlled by adjusting the fluid velocity of the coagulation fluid.

It will be apparent to one of ordinary skill in the art that the fiber-formation tube 12 need not be exactly vertical but can instead be canted at an angle relative to the direction of the gravitational force vector or any other force field acting on the fiber. What is important is that the fiber-formation tube 12 be oriented such that the force exerted by the laminar flow prevents the fiber from contacting the inner wall 18 of the fiber-formation tube 12 as the fiber proceeds from the coagulation zone 46 to the fluid outlet 70.

A perfectly vertical fiber-formation tube 12 has the desirable property that the gravitational force has no component that directs the fiber toward the inner wall 18. However, a canted fiber-formation tube 12 can be used, provided that the radially-inward force exerted by the laminar flow is sufficient to overcome the component of gravitational force directed toward the inner wall 18. The range of suitable angles at which the fiber-formation tube 12 can be canted will be determined in part by the coagulation fluid flow velocity, the coagulation fluid viscosity, the density of the fiber, the fiber diameter, and the diameter of the bore 20. Hence, as used in the specification and claims, the terms “substantially vertical” or “generally vertical” refer to orientations such that laminar flow prevents the fiber from contacting the inner wall 18 of the fiber-formation tube 12.

The fiber-formation apparatus 10 and method disclosed herein offers numerous advantages. It is known, for example, that a typical biopolymer fiber resists forces directed along its axis more readily than transverse forces. Because the fiber in the disclosed apparatus is suspended generally vertically, the predominant force acting on the fiber, which is that due to its own weight, is directed along the fiber's axis. Since the fiber is not subject to excessive transverse forces, it is unlikely to fragment during formation. As a result, it is possible to form extremely long and very fine continuous fibers.

Another advantage of the apparatus and method disclosed herein is that since the fiber-formation tube 12 through which coagulation fluid flows has such a narrow bore 20, only a small volume of coagulation fluid is necessary to coagulate the stream of liquid biopolymer extruded from the spinneret 30. As a result, it is economically feasible to discard the coagulation fluid after use. Because the coagulation fluid in contact with the fiber comes directly from the coagulation-fluid reservoir 24, it is consistent in composition and pH. As a result, it is more likely that a fiber manufactured in the manner disclosed herein will be uniform in its properties. An additional advantage of the narrow bore fiber-formation tube 12 disclosed herein is that low-viscosity coagulation fluids can be used. Such coagulation fluids are simpler to formulate and prepare than high-viscosity coagulation fluids and enable extremely fine fibers to be readily separated from the coagulation fluid without use of mechanical supports that make physical contact with the fiber.

Yet another advantage of the apparatus and method disclosed herein is that the coagulation fluid is completely enclosed by the fiber-formation tube 12. Hence, there is little or no likelihood that any coagulation fluid will be lost due to evaporation or that the concentration of coagulating agent in the coagulation fluid will change as a result of evaporation. In addition, there is less likelihood that the coagulation fluid, and potentially the fiber itself, will be contaminated by airborne particulate matter or microorganisms.

Because virtually no mechanical stresses are imposed on the fiber in the coagulation zone 46, the rate of fiber formation need not be constrained by efforts to avoid mechanical stress. The rate of fiber formation is thus limited only by how rapidly the fiber can be extruded from the spinneret 30 and how rapidly the fiber can be made to coagulate and flow down the fiber-formation tube 12. As a result, the throughput associated with fiber formation can be much higher than is achievable with conventional methods.

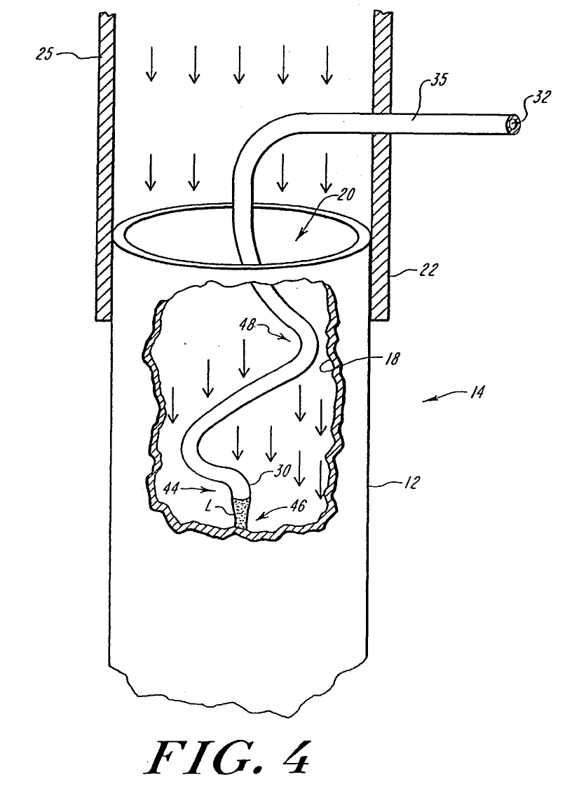

A variety of methods are available for anchoring the spinneret 30 so that liquid biopolymer is extruded along an axis coaxial with the axis X of the fiber-formation tube 12. A typical method, shown in the cut-away view of the upper end 14 of the fiber-formation tube 12 in FIG. 4, is to provide an anchoring element 48 extending between an outer wall of the spinneret 30 and the inner wall 18 of the fiber-formation tube 12. The anchoring element 48 is adapted to suspend the spinneret 30 in the bore 20 of the fiber-formation tube 12. A simple anchoring element 48, such as that shown in FIG. 4, is formed by bending the biopolymer feeder tube 35 so as to form a bent section. An anchoring element 48 formed in this manner engages the inner wall 18 of the fiber-formation tube 12 and applies a radially directed outward force against the inner wall 18. The anchoring element 48 thereby fixedly secures the spinneret 30 within the bore 20 and coaxial with the fiber-formation tube 12.

In anchoring the spinneret 30 in the bore 20, it is preferable that any non-uniform flow generated by the anchoring element 48 dissipate before reaching the point at which the spinneret 30 extrudes the stream of liquid biopolymer into the coagulation fluid. Consequently, it is preferable that the anchoring element 48 be located well upstream of this point. As shown in FIG. 4, the anchoring element 48 is located far enough upstream from the point at which the spinneret 30 extrudes liquid biopolymer L to ensure uniform flow.

With reference to FIG. 1, an apparatus according to the invention can optionally include a propulsion fluid inlet 50 coupled to the fiber-formation tube 12 at a point downstream from the spinneret 30. Preferably, the diameter of the fiber-formation column 12 is enlarged at the point at which the propulsion fluid inlet 50 joins the fiber-formation column 12. The propulsion fluid inlet 50 is connected to a propulsion fluid source 52 and provides a flow of propulsion fluid to assist the coagulation fluid in propelling the biopolymer stream toward the lower end 16 of the fiber-formation tube 12. The propulsion fluid source is connected to a head source 53 for driving the propulsion fluid into the fiber-formation tube 12. The configuration for driving the propulsion fluid is similar to that already discussed in connection with the biopolymer reservoir 34.

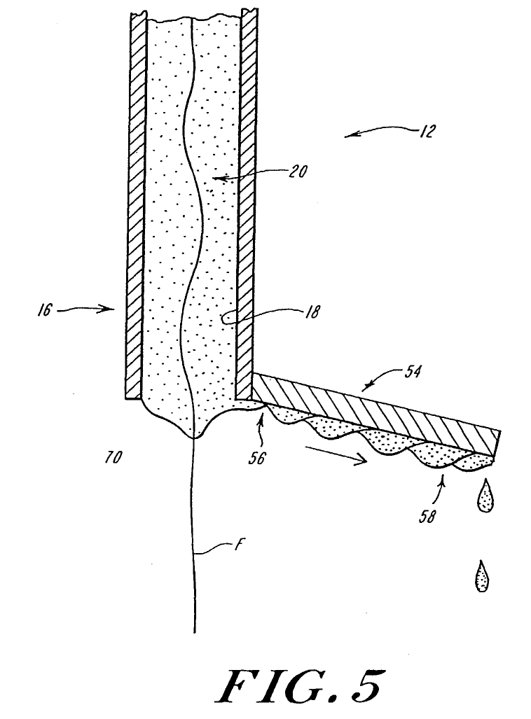

A wet biopolymer fiber is typically significantly more fragile than a dry fiber. In cases where a dry fiber is required, it is desirable that the wet fiber emerging from the lower end 16 of the fiber-formation tube 12 be dried before being wound onto a spool. To accelerate the drying process, the apparatus can include a fluid diverter 54 disposed at the lower end 16 of the fiber-formation tube 12, as shown in FIG. 5, for separating the fiber from the coagulation fluid.

At a fluid outlet 70 located at the lower end 16 of the fiber-formation tube 12, the bulk of the coagulation fluid that has not been absorbed by the fiber itself clings to the inner wall 18 of the fiber-formation tube 12. A suitable fluid diverter 54 can thus be a plate having a fluid-capturing end 56 proximal to the fluid outlet 70 and a fluid-drainage end 58 distal to the fluid outlet 70. The plate is held at an incline with the fluid-drainage end 58 lower than the fluid-capturing end 56. As a result of this incline, coagulation fluid that flows onto the fluid-capturing end 56 flows radially away from the fiber and toward the fluid-drainage end 58.

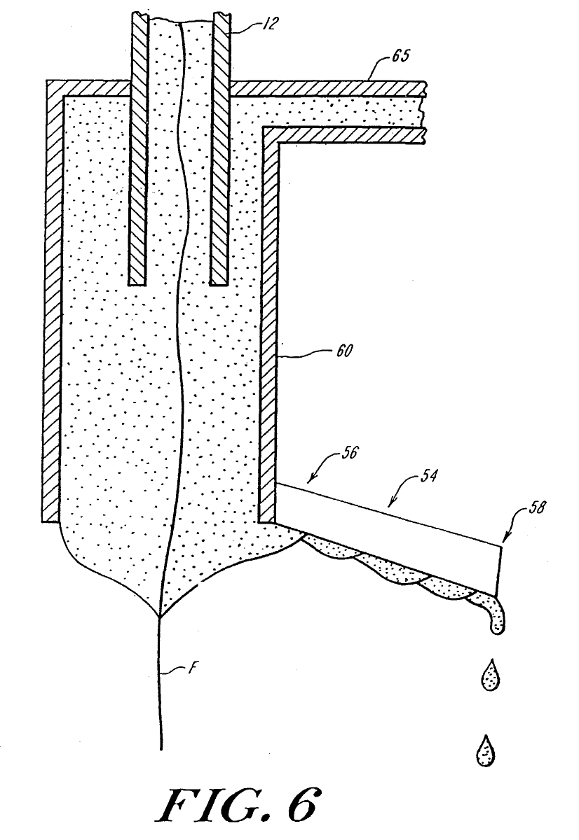

To further assist the drying process, an apparatus 10 incorporating the principles of the invention can further include a dehydration tube 60 mounted coaxially with the fiber-formation tube 12, as shown in FIG. 6. The dehydration tube 60 is coupled to a dehydration-fluid reservoir 64 by a dehydration-fluid feed tube 65. A head source 67 in fluid communication with the dehydration-fluid reservoir 64 forces dehydration-fluid from the dehydration-fluid reservoir 64, through the dehydration-feed tube 65, and into the dehydration tube 60. The dehydration fluid can also be fed through a metering pump.

In an embodiment incorporating the illustrated dehydration tube 60, the biopolymer fiber, which is wetted by coagulation fluid, passes coaxially through the dehydration tube 60 where it is placed into contact with dehydration fluid. The dehydration fluid is selected to displace water contained in, and coagulation fluid absorbed by, the biopolymer fiber and also to evaporate readily when exposed to air. The surface of the biopolymer fiber F emerging from the dehydration tube 60 is thus wetted predominantly by dehydration fluid which evaporates far more readily than coagulation fluid.

In another embodiment, the fiber-formation tube 12 is horizontal. In such an embodiment, the fiber is preferably very light and the coagulation-fluid flow velocity is relatively high so that the laminar flow of coagulation fluid can maintain the position of the fiber away from the inner wall 18.

The biopolymer fiber formed by the apparatus of the invention can be treated with cross-linking agents to control the rate of modeling and to add strength to the fiber. Crosslinking agents can be included in any part of the fiber formation process. For example, they can be used to treat unpolymerized collagen, coagulated wet fiber, or dry fiber. The point at which the cross-linking agent is included in the process depends on the type of cross-linking agent used. Cross-linking agents known in the art include glutaraldehyde, formaldehyde, sugars, bisacrylamides, acrylamide, carbodiimides, such as 1-ethyl-3-(dimethyaminopropyl) carbodiimide, diones such as 2,5-hexanedione, diimidates, such as dimethylsuberimidate, or bisacrylamides, such as N,N′-methylenebisacrylamide.

The biopolymer fiber formed by the apparatus or method of the invention can then be seeded with extra-cellular matrix particulates, DNA, or stem cells and bathed in drugs or growth factors so as simulate, as closely as possible, a naturally occurring fiber or a fiber with enhanced biochemical signaling properties. Alternatively, additives such as growth factors, drugs, and other materials can be added to the liquid biopolymer in the biopolymer reservoir 34 so that they pervade the entire volume, and not just the surface of the collagen fiber formed by the apparatus of the invention. This can result in the continuous release of these additives over time as the fiber, now implanted in vivo, undergoes remodeling. Such a fiber, when implanted into a patient, can then serve as a suitable scaffolding for encouraging growth of natural tissue and accelerating the patient's healing process.

A suitable biopolymer is one that can form a biocompatible foam or sponge-like structure. The biopolymer is non-toxic and bioabsorbable. Further, the product of degradation of the biopolymer is non-toxic. These biopolymers include collagen, algenic acid, polyvinyl alcohol, proteins, such as laminin, fibronectin or fibrinogen activated with thrombin to form fibrin. A preferred source material for a biopolymer consists of collagen and, in particular, the skins from near-term, domestic porcine fetuses which are harvested intact, enclosed in their amniotic membranes. Collagen can be derived from other suitable animal source, such as porcine, bovine, ovine or marine animals and from many tissues, such as dermis, tendons, dental and connective tissue, as well as others. Embryonic and fetal tissues are advantageous because they include various molecular factors which are present in normal tissue at different stages of animal development. A mix of biopolymers can be used. In one embodiment, the biopolymers are collagen and fibronectin. The biopolymer can be used to create foams in the form of strips, sheets, tubes and other shapes. The shapes can be in the form of tissues or body parts to be replaced and constitute prostheses. Extracellular matrix particulates can be bonded to the biopolymers.

Extracellular matrix particulates can be taken from specific tissues. The particulates have two kinds of informational properties. The first is their molecular diversity, and the second is their microarchitecture both preserved in the preparation of the microparticulates. The preferred associations among the different molecules of the extracellular matrix are also preserved in the preparation of the microparticulates.

The extracellular matrix plays an instructive role, guiding the activity of cells which are surrounded by it or which are organized on it. Since the execution of cell programs for cell division, morphogenesis, differentiation, tissue building and regeneration depend upon signals emanating from the extracellular matrix, three-dimensional scaffolds are enriched, such as collagen sponges and foams with actual matrix constituents, which exhibit the molecular diversity and the microarchitecture of a generic extracellular matrix, and of extracellular matrices from specific tissues.

The extracellular matrix particulates can have cytokines, including growth factors necessary for tissue development. These biomolecular factors are present in normal tissue at different stages of tissue development, marked by cell division, morphogenesis and differentiation. Among these factors are stimulatory molecules that provide the signals needed for in vivo tissue repair. These cytokines including growth factors, being part of the extracellular matrix microparticulates, can stimulate conversion of an implant into a functional substitute for the tissue being replaced. This conversion can occur by mobilizing tissue cells from contiguous like tissues, from the circulation and from stem cell reservoirs; it can promote cell division, morphogenesis and differentiation. Cells can attach to the prostheses which are bioabsorbable and can remodel them into replacement tissues.

Growth factors necessary for cell growth are attached to structural elements of the extracellular matrix. The structural elements include proteins, glycoproteins, proteoglycans and glycosaminoglycans. The growth factors, originally produced and secreted by cells, bind to the extracellular matrix and regulate cell behavior in a number of ways. These factors include, but are not limited to, epidermal growth factor, fibroblast growth factor (basic and acidic), insulin growth factor, nerve growth-factor, mast cell-stimulating factor, platelet-derived growth factor, the family of transforming growth factor-d, platelet-derived growth factor, scatter factor, hepatocyte growth factor and Schwann cell growth factor. Adams et al., “Regulation of Development and Differentiation by the Extracellular Matrix” Development Vol. 117, p. 1183-1198 (1993) (hereinafter “Adams et al.”) and Kreis et al., editors of the book entitled “Guidebook to the Extracellular Matrix and Adhesion Proteins,” Oxford University Press (1993) (hereinafter “Kreis et al.”) provide contributions which summarize extracellular matrix components that regulate differentiation and development and describe the regulatory mechanisms involved and that growth factors and extracellular matrix molecules interact in a number of ways to regulate cell behavior. Further, Adams et al. disclose examples of association of growth factors with extracellular matrix proteins and that the extracellular matrix is an important part of the micro-environment and, in collaboration with growth factors, plays a central role in regulating differentiation and development. The teachings of Adams et al. and Kreis et al. are incorporated herein by reference.

The method for forming extracellular matrix particulates for producing graft tissue includes freezing a tissue source having living cells, whereby the living cells are disrupted to form cell remnants. The tissue source is then cryomilled to produce particulates which are thawed and are processed leaving extracellular matrix particulates including cytokines. The term cytokines includes but is not limited to growth factors, interleukins, interferons and colony stimulating factors. The process of washing removes the cell remnants without removing growth and other factors necessary for cell growth, morphogenesis and differentiation. The extracellular matrix is freeze-dried and, if desired, further fragmented.

The invention is further illustrated by the following non-limiting examples.

### EXAMPLE 1

The preparation of an embodiment of a fibrous biopolymer of the invention is illustrated in the following example. Collagen fiber is ‘spun’ by neutralizing a flow of acidic monomeric collagen in a flow of coagulation buffer contained within a small diameter vertical pipe column. The collagen has an initial pH range of about 2.0 to 4.0, and is introduced into the buffer flow through a spinneret mounted near the top of the column, as illustrated previously in the present application. Collagen fiber is formed within the tube and is transported by laminar flow through the column.

The preferred spinneret needle position, in the present embodiment, is a coaxial configuration such that the outlet of the spinneret tube is centered in the bore of the fiber formation tube. The spinneret tube is made in this instance from stainless steel No. 28 gauge thin-wall hypodermic tubing (0.009″ ID×0.014″ OD), 2.5″ long with a blunt cut and polished outlet. The spinneret tubing is bent in three places such that the two bends furthest from the outlet form a shallow reverse curve, the shoulders of which contact the inside wall of the fiber formation tube, and in combination with the third bend nearer the spinneret outlet provide centering of the outlet within the fiber formation tube. The spinneret outlet can be centered by other means, such as the use of thin projecting structures from the fiber formation tube interior wall or the spinneret exterior wall as long as the coagulation bath flow downstream of these structures is sufficiently uniform to allow for the steady polymerization and transport of a uniform fiber through the fiber formation tube, which is desired. The fiber formation tube is a stainless steel No.19 gauge hypodermic tube (0.032 inch ID) 34 inches long. The fiber coagulation pathway is approximately 32 inches long when the spinneret tube is inserted 2 inches into the upper end of the fiber formation tube. A seal is formed by where the spinneret tube penetrates the elastomeric tubing connected to the inlet end of the fiber formation tube. The seal prevents fluid leakage and the entry of air into the system. These sizes can be enlarged or decreased as needed, providing that the resulting flow is laminar in the zone of the spinneret outlet.

Buffer compositions used are, e.g., 50 mM or 100 mM triethanolamine (TEA buffer) of pH 7.5, or 100 mM N-(2-hydroxyethyl)piperazine-N′-(2-ethanesulfonic acid) (HEPES buffer) of pH 7.5, although many bath compositions and pH ranges will produce fiber in the system. Coagulation bath temperatures may be varied from about 4° C. to 37° C. Combined bath and collagen flow rates used (with 0.032 inch ID tube) are below 10.0 ml/min and the collagen flow rate is below 0.5 ml/min. for a monofilament fiber. Flow of all fluids is maintained by controlling the pressure of a nitrogen head over each fluid in pressurized dispensing bottles. The collagen bottle reservoir is kept at a temperature of 4° C. Collagen concentration (acid extracted) may range from 5 mg/ml to 40 mg/ml or higher. Collagen pressures range from 5 psi to 35 psi. Note that pepsin-extracted collagen may also be spun into fiber in the system.

Buffer and buffer coated collagen fiber exits at the lower outlet of the fiber formation tube and is collected in a bottle of suitable size for the period of operation. The buffer exits the column in the form of droplets and the fiber can be segmented by the action of the falling droplets provided a sufficient headspace above the liquid level in the bottle exits. The fiber, when spun with appropriate operating parameters, can also be made to exit the column as a continuous strand either through a headspace or by immersing the outlet in liquid in the collection bottle.

The entire process is accomplished aseptically resulting in collected fiber that is sterile in its container.

### EXAMPLE 2

To illustrate a use of collagen fibers in accordance with another aspect of the invention, to demonstrate the utility of percutaneous injection of a material of the invention to cosmetically remove wrinkles, the following experiment was conducted.

Collagen at 20 mg/ml was spun for 24 hours into 50 mM TEA, pH 7.5 at 25 psi with a 3 ml/min buffer flow rate, using the procedure generally outlined in Example 1. There was a 525 cm variable gap between column exit and the collection bottle liquid level. Once the TEA buffer had been removed, the fibers were washed with IL of sterile Milli-Q™ water in a sieve.

The hydrated fibers were removed from the sieve with sterile forceps and placed in sterile 1.0 ml syringes having a 22 gauge needle attached. Hairless, immune competent, mice were anesthetized. 0.3 ml of fibers were ejected out of the syringe, through the 22 gauge needle, percutaneously at a site between the ears and/or the back of the neck of the mice. The wrinkles plainly evident at the injection site before injection were grossly removed as a result of the bolus of material placed percutaneously at the injection site. It is important to note that prior to injection, the fibers could first also be combined with a variety of signals, e.g., BMPs, and hedgehog proteins, cells, genes, drugs, antibiotics, etc.

One month after injection, the bolus of collagen fibers was still plainly evident at the injection sites and the volume of material appeared comparable to the initial amount injected. No inflammation was observed at the injection site and the wrinkles were still grossly removed.

### EXAMPLE 3

An important application of fibers in accordance with the invention, e.g., collagen fibers, is in the development of skin replacement materials, such as is illustrated in this example.

Collagen fibers were prepared and washed generally as in Example 2. The fibers were crosslinked using genipin, which may be utilized at concentrations ranging from 0.02 to 0.83 mg/ml (preferably 0.05 to 0.21 mg/ml) in 20 mM HEPES buffer, pH 7.5. (Various liquids, including buffers and organic solvents such as ethanol can be used for the crosslinking with genipin, but HEPES buffer is preferred, at concentrations ranging from 5 to 500 mM, preferably 20 mM.) Crosslinking proceeded for at least 3 hours, but may be also done in the preferable range of between about 12 and 30 hours. After crosslinking, the fibers were washed with deionized water and prepared for freeze drying. The fibers were spread into 10×10 cm polystyrene tissue culture dishes and the surface of the fiber mass was made smooth. Deionized water was added to be level with the surface of the fiber mass and the dish of fibers was freeze-dried.

In vitro studies were performed several times with reproducible seeding and growth characteristics. Cells used for these experiments were dermal fibroblasts. Cell growth was studied on the scaffolds for durations of up to 3 weeks. The scaffolds with fibers crosslinked by the preferred method showed very good attachment and growth characteristics and little contraction.

In vivo rat skin wound implant studies were performed also. The implanted scaffolds were 8 mm diameter circles cut from 10×10 cm scaffolds. The hair on the rats was removed by clipping and then depilating with a commercially available hair removal product. An 8 mm biopsy punch was used to create two wounds on the back of each rat. A scaffold was inserted into each wound, which then was covered with a layer of buffer-soaked absorbent pad and then a layer of an occlusive bandage to keep the wound moist. The rats were allowed to heal for one or two weeks. After the healing periods, wound sites were harvested and processed for histological observation.

All scaffolds were well taken and seeded by recipient cells. By two weeks, some scaffolds were completely remodeled by incoming cells, which partially digested the scaffold's fiber and deposited new collagenous matrix. Most wounds showed newly developed dermal and epidermal tissues with a fully differentiated epidermal component over the scaffolds. Most scaffolds were well integrated and showed much vascular activity (pictures available). Some scaffolds (with lower concentration of crosslinking agent) were “cut through” by migrating keratinocytes. The wounds containing scaffolds with fibers crosslinked by the preferred method showed little contraction.

Equivalents

Those skilled in the art will recognize, or be able to ascertain using no more than routine experimentation, numerous equivalents to the specific procedures described herein. Such equivalents are considered to be within the scope of the present invention and are covered by the following claims. The contents of all references, issued patents, and published patent applications cited throughout this application are hereby incorporated by reference. The appropriate components, processes, and methods of those patents, applications and other documents may be selected for the present invention and embodiments thereof. All parts and percentages mentioned herein are by weight unless otherwise specified.

What is claimed is:

1. A bio-compatible material having a microstructure which is amenable to infiltration by living cells and which supports substantial and extended occupation by living cells.

2. The bio-compatible material of claim 1 which comprises a biopolymer.

3. The bio-compatible material of claim 1 that is injectable.

4. The bio-compatible material of claim 3, further comprising a physiologically compatible carrier.

5. The bio-compatible material of claim 1, wherein said microstructure further comprises an agent selected from the group consisting of pharmaceuticals, growth factors, hormones, extracellular matrix components, genetic matter, cells and combinations thereof.

6. The bio-compatible material of claim 5, wherein said genetic matter comprises a viral vector.

7. The bio-compatible material of claim 1, wherein said material comprises collagen.

8. A fibrous bio-compatible material comprising a linearly assembled biopolymer fiber, which is assembled from biopolymer fibrils whose axes are substantially parallel with the axis of said biopolymer fiber.

9. The fibrous bio-compatible material of claim 8 that is injectable.

10. The fibrous bio-compatible material of claim 8, comprising a plurality of said linearly assembled biopolymer fibers.

11. The fibrous bio-compatible material of claim 10, wherein said linearly assembled biopolymer fibers are of heterogeneous length.

12. The fibrous bio-compatible material of claim 8, wherein said linearly assembled biopolymer fiber is of a form having a plurality of microfibrillar tangential protrusions.

13. The fibrous bio-compatible material of claim 10, wherein the lengths of said linearly assembled biopolymer fibers are effective to cause entanglement with other bio-compatible material fibers.

14. The fibrous bio-compatible material of claim 10, wherein the lengths of said linearly assembled biopolymer fibers is from about 1 cm to about 8×10⁵ cm.

15. The fibrous bio-compatible material of claim 8, further comprising a physiologically acceptable carrier.

16. The fibrous bio-compatible material of claim 8, wherein said linearly assembled biopolymer fibers comprise an agent selected from the group consisting of pharmaceuticals, growth factors, hormones, extracellular matrix components, genetic matter, cells, and combinations thereof.

17. The fibrous bio-compatible material of claim 16, wherein said genetic matter comprises a viral vector.

18. The fibrous bio-compatible material of claim 8, wherein said biopolymer is collagen.

19. The fibrous bio-compatible material of claim 8, further comprising a collagen foam.

20. The fibrous bio-compatible material of claim 19, wherein the collagen is fibrillar collagen.

21. A method of ameliorating a tissue deficit or disorder, comprising contacting the site of said tissue deficit or disorder with a bio-compatible material having a microstructure which is amenable to infiltration by living cells and which supports substantial and extended occupation by living cells.

22. The method of claim 21 wherein said tissue deficit or disorder is selected from the group consisting of bone disease, cartilage disease, cosmetic defects, dermal wounds caused by circulatory disorders, and dermal wounds caused by diabetes.

23. The method of claim 21, where said bio-compatible material is applied directly onto said tissue deficit or disorder.

24. The method of claim 21, where said bio-compatible material is injected percutaneously to ameliorate said tissue deficit or disorder.

25. The method of claim 21, wherein said biocompatible material comprises a plurality of linearly assembled biopolymer fibers which are assembled from biopolymer fibrils whose axes are substantially parallel with the axis of said biopolymer fibers.

26. The method of claim 24, wherein said biocompatible material is obtained by freeze-drying a suspension of collagen fibrils.

27. The method of claim 25, wherein said length of said linearly assembled biopolymer fibers is from about 1 cm to about 8×10⁵ cm.

28. The method of claim 21, wherein said biocompatible material is contained in a physiological compatible carrier.

29. The method of claim 25, wherein said linearly assembled biopolymer fibers have a microstructure comprising a form having a plurality of microfibrillar tangential protrusions.

30. The method of claim 25, wherein upon percutaneous injection of said composition, said fibers entangle to form a porous mass.

31. The method of claim 30, wherein the pores in said porous mass have a diameter of from about 1 μm to about 1000 μm.

32. The method of claim 21, wherein said biopolymer comprises collagen.

33. The method of claim 24, wherein said biopolymer comprises fibrillar collagen foam.

34. The method of claim 24, wherein said biopolymer comprises a collagen matt.

35. The method of claim 25, wherein said linearly assembled biopolymer fibers comprise an agent selected from the group consisting of pharmaceuticals, growth factors, hormones, extracellular matrix components, genetic matter, cells and combinations thereof.

36. The method of claim 35, wherein said genetic matter comprises a viral vector.

37. An injectable biopolymer fiber made by a process comprising:
a) creating a vertically-directed flow of coagulation fluid having an upstream direction and a downstream direction,
b) injecting, into the downstream direction of the vertically-directed flow of coagulation fluid, a stream of uncoagulated biocompatible biopolymer selected to coagulate in response to contact with the coagulation fluid, the stream being injected so as to be surrounded by coagulation fluid and propelled in the downstream direction by the vertically-directed flow of coagulation fluid, and
c) allowing the coagulation fluid to coagulate the biopolymer stream, thereby forming a biopolymer fiber.

38. The injectable biopolymer fiber of claim 37 wherein said uncoagulated biocompatible biopolymer is a liquid collagen solution.

39. The injectable biopolymer fiber of claim 38 wherein said liquid collagen solution has a concentration of from about 1 mg/ml to about 60 mg/ml.

40. The injectable biopolymer fiber of claim 38 wherein said coagulation fluid is a buffer.

41. The injectable biopolymer fiber of claim 37 further comprising the step of selecting said coagulation fluid to be a solution of triethanolamine.

42. The injectable biopolymer fiber of claim 37, wherein said triethanolamine concentration is from about 10 mM to about 200 mM.

43. The injectable biopolymer fiber of claim 37, wherein said coagulation fluid is a solution of HEPES having a concentration of about 100 mM.

44. The injectable biopolymer fiber of claim 37, wherein said biocompatible biopolymer is maintained at a temperature of approximately 4° C.

45. The injectable biopolymer fiber of claim 37, wherein said coagulation fluid is maintained at a temperature of from about 4° C. to about 37° C.

46. A tissue replacement material comprising a plurality of linearly assembled collagen fibers, which are assembled from collagen fibrils whose axes are substantially parallel with the axis of said collagen fiber.
